(19) United States
(12) Patent Application Publication
(10) Pub. No.: US 2023/0120483 A1
(43) Pub. Date: Apr. 20, 2023

(54) IMPROVED RESIN SYSTEM FOR INTUMESCENT COATINGS

(71) Applicant: Röhm GmbH, Darmstadt (DE)

(72) Inventors: Bruno Keller, Wackernheim (DE); Sven Balk, Frankfurt (DE)

(73) Assignee: Röhm GmbH, Darmstadt (DE)

(21) Appl. No.: 17/905,888

(22) PCT Filed: Feb. 26, 2021
(86) PCT No.: PCT/EP2021/054789

§ 371 Date: Sep. 8, 2022

(30) Foreign Application Priority Data
Mar. 11, 2020 (EP) 20162308.9

(51) Int. Cl. C08F 220/14; C08F 220/28; C09D 5/18; C09D 133/12; C09D 133/14

(52) U.S. Cl. CPC C08F 220/14; C08F 220/283; C09D 5/185; C09D 133/12; C09D 133/14

(57) ABSTRACT

An innovative reactive resin system can be used for intumescent coating. Intumescent coatings are used in particular for fire protection of metallic components, such as girders in structural engineering. In a fire scenario, these coatings are reactively foamed and so form a fire-resistant insulating layer with low thermal conductivity around the metal girder, with the resultant insulation retarding premature failure of this component. The resin systems are prepared by an innovative process where the monomer fraction is polymerized only up to a maximum degree of 70%. The glass transition temperature of this polymeric component of the resultant composition is particularly low.

### FIELD OF THE INVENTION

The present invention relates to an innovative reactive system for intumescent coating and to a process for preparing this resin system. Intumescent coatings are used in particular for fire protection of metallic components, such as girders in structural engineering. In a fire scenario, these coatings are reactively foamed and so form a fire-resistant insulating layer with low thermal conductivity around the metal girder, with the resultant insulation retarding premature, thermally induced failure of this component.

The present invention relates more particularly to resin systems which are prepared by means of an innovative process wherein the monomer fraction is polymerized only up to a maximum degree of 70%. The glass transition temperature of this polymeric component of the resultant composition is particularly low by comparison with the prior art.

### PRIOR ART

A first generation of the intumescent coating systems was based on high molecular weight thermoplastic resins themselves based on acrylates, methacrylates and/or vinyl monomers, said systems requiring a large solvent or water fraction for application to the appropriate metal surface, with correspondingly long drying times.

Such intumescent coatings are typically applied on-site during the construction phase. Preference, however, is given to off-site application before delivery to the building site, since this form of application can take place under controlled conditions. A result of slow drying, however, is inefficient working time, especially as the coating has to be made from different sides in succession in order to be complete.

Epoxy-based intumescent coatings are used preferably in the off-shore industry. Their qualities include high ageing resistance and relatively short drying times. Polyurethane systems have been studied intensely. Their qualities include, again, a relatively short drying time, and good water resistance. Here, however, the fire tests had a negative outcome, since the coating does not adhere well to steel. Details of this can be consulted in Development of alternative technologies for off-site applied intumescent, Longdon, P. J., European Commission, [Report] EUR (2005), EUR 21216, 1-141.

A further generation of intumescent coatings is based on (meth)acrylate reactive resins. Applying these resins has the great advantage that in this case no solvents are needed, instead, the resin cures relatively quickly, by comparison, after application. The result is not only more rapid working but also, in particular, a reduced fraction of residual volatile constituents in the applied coating. Intumescent coating systems of this kind were first disclosed in EP 1 636 318.

A further improvement of the (meth)acrylate-based systems was subsequently disclosed, for example, in EP 2 171 004. A notable feature here is a particularly high fraction of acid groups to improve the metal adhesion.

EP 2 171 005 discloses an onward development of a system of this kind. This development is notable in particular for copolymerization of dibasic acids or copolymerizable acids with a spacer group. In this way the metal adhesion can be additionally improved.

All of these systems, however, are subject still to a need for improvement. For instance, the degrees of freedom in terms of formulatability are severely restricted. Moreover, only relatively thick coats can be applied. As a result of these disadvantages in combination, for example, it is also the case that there is a limit to the predeterminability of the foam height in a demand/fire scenario,

In addition, disadvantages also arise from the relatively complex process by which the resins are prepared. A feature common to all (meth)acrylate systems described in the prior art, which are otherwise very advantageous, is that the solid, thermoplastic polymer contained in the resin is first prepared separately, then dissolved in the monomer components and preformulated with additives, and lastly, shortly before application, given its end-use formulation as a 2-component system. This process chain is relatively inconvenient, and there is great interest in its simplification.

### Object

The present invention was therefore based on the object of providing a significantly simplified process for producing (meth)acrylate-based intumescent coatings.

More particularly there was a need for a simplified production process permitting the saving of at least one insulation step or formulation step relative to the processes described in the prior art for producing (meth)acrylate-based intumescent coatings.

A further object was that of providing an innovative formulation for 2-component intumescent coating which, in addition to very good metal adhesion and ease of workability, additionally allows greater freedoms with respect to additization and to the establishment of subsequent foaming control, particularly with regard to the predetermination of later foam heights and foam quality, such as, for example, a particularly high fraction of closed-pore foam.

Further objects, not explicitly stated, may become apparent hereinafter from the description or from the examples, and also from the overall context of the invention.

### Achievement

These objects are achieved by means of an innovative process for preparing reactive resins for intumescent coatings. This innovative process is characterized in that a monomer mixture comprising at least one acid-functional monomer is polymerized to a degree of polymerization of not more than 70%, discontinuously in batch mode or continuously in a continuous stirred tank with subsequent flow tube. At this point the polymerization is discontinued. The process is further characterized in that the polymer formed in the process has a glass transition temperature of less than 23° C., preferably less than 20° C. and more preferably less than 15° C. With particular preference, the glass transition temperature of the polymer formed at the time of the discontinuation of polymerization in accordance with the process is at least −20° C., more preferably at least −10° C.

The degree of polymerization on discontinuation of the polymerization is preferably between 10 and 50 wt %, more preferably between 20 and 40 wt %.

It has proven, surprisingly, to be particularly advantageous if the polymer formed in the process of the invention has a glass transition temperature below the surrounding room temperature, hence if said polymer would be liquid at room temperature even in the isolated state.

The monomer mixture preferably consists to an extent of at least 90 wt % of acrylates and/or methacrylates. More preferably the monomer composition here comprises 20 to 60 wt %, more preferably 25 to 50 wt % of MMA.

The acid-functional monomer preferably comprises acrylic acid, methacrylic acid, itaconic acid and/or 2-carboxyethyl acrylate, more preferably 2-carboxyethyl acrylate. Preferably up to 5 wt % of the acid-functional monomers is used in the monomer mixture.

Besides the acid-functional monomers, the monomer composition comprises further monomers preferably selected from MMA, n-butyl (meth)acrylate, isobutyl (meth)acrylate, ethyl (meth)acrylate, propyl (meth)acrylate, ethylhexyl (meth)acrylate and/or styrene.

In one particular embodiment of the process of the invention, the monomer mixture may additionally comprise a crosslinking agent which contains up to 3 wt %, preferably up to 1 wt %, more preferably up to 0.3 wt %, of di- or trifunctional (meth)acrylates or triallyl cyanurates. The amount of these crosslinking monomers is established more particularly such that, depending on the molecular weight, the degree of polymerization and the rest of the monomer mixture, there is no crosslinking, but instead only branching of the polymer chains formed. This can be achieved by a skilled person with just a few tests as a function of the rest of the parameters referred to.

The polymeric constituent on discontinuation of the polymerization preferably has a weight-average molecular weight Mw of between 10 000 and 200 000 g/mol, preferably between 20 000 and 150 000 g/mol and more preferably between 30 000 and 100 000 g/mol. The weight-average molecular weight here is implemented by means of GPC against a PMMA standard, using at least four suitable columns, with THF as eluent.

As well as the process of the invention, another subject of the present invention is a formulation for 2-component intumescent coatings. This formulation is characterized in particular in that at a time after mixing of the 2-component system, it contains 30 to 50 wt % of the reactive resin prepared by means of the process of the invention, 35 to 60 wt % of a blowing agent, 0.1 to 2.5 wt % of a peroxide and/or azo initiator, preferably only peroxides such as, for example, benzoyl peroxide, optionally up to 2 wt % of an accelerator, optionally 4.9 to 15 wt % of additives and 5 to 30 wt % of fillers. The formulation may optionally contain additional pigments.

The additives may more particularly be wetting agents, film formers, deaerating reagents and/or dispersing assistants. The accelerators optionally employed are, in general, secondary amines.

The fillers may be, for example, silicon dioxide, titanium dioxide, quartz or other compounds, especially inorganic compounds that are thermally stable. Inorganic fillers such as carbonates, which may undergo thermal decomposition, may be used only to a relatively small degree, in order to avoid uncontrolled additional foaming of the coating in a fire scenario. A particularly preferred filler is titanium dioxide.

With regard to the blowing agents, there are various alternatives. In one particularly preferred alternative it is possible to use polyphosphates which react at 190 to 300° C. to form phosphoric acid. Additionally the formulation comprises pentaerythritol, which forms a carbon foam subsequently at above 300° C. in the presence of the phosphoric acid, with elimination of water and carbon dioxide. This water and carbon dioxide act as blowing agents. An additional advantage of this alternative is that the polyphosphates and the phosphoric acid act as an additional flame retardant.

A second alternative uses melamine, which is decomposed at above 350° C. to form ammonia, nitrogen, and carbon dioxide, all three of which act as blowing agents.

Through a combination of these two alternatives it is possible additionally to realize further advantages as well as the flame retardancy. Hence the degree of foaming can be established with greater precision. There is also a graduated foaming, which in turn brings advantages in relation to foam stability. The initiator system consists in general of one or more peroxides and/or azo initiators, preferably a peroxide, and of an accelerator, in general one or more tertiary amines, more particularly an aromatic tertiary amine. A particularly suitable example of such an initiator is dibenzoyl peroxide, which may also be used, for example, as a safe, preformulated paste, in which case the auxiliaries in this paste, such as paraffins, for example, have no disruptive effect at the appropriate concentrations in the formulation. Particular examples of the accelerators are N,N-dialkyl-para-toluidines, such as, for example, N,N-bis(2-hydroxyproyl)-para-toluidine or N,N-dimethyl-para-toluidine, or N,N-dimethylaniline.

The coating composition itself may be formulated as follows: the reactive resin is formulated with the blowing agents, additives, optional fillers and further optional fillers. These intermediate formulations are divided into two fractions of equal size, for example. One of these fractions is then additionally mixed with the accelerator, These two fractions are subsequently stable on storage for a long time.

Before the actual application, the accelerator-free fraction is then admixed with the initiator or initiator mixture. Following prolonged storage or transportation, it may be necessary beforehand to agitate the two fractions again, owing to the possible settling of fillers, for example. After the initiator has been incorporated by stirring or by other forms of mixing, the two fractions of the 2-component system are then mixed with one another. The polymerization of the monomer constituents of the reactive resin is commenced, and this is the start of what is called the pot life, within which the formulation must be applied to the substrate—that is, for example, a steel girder, With modern application equipment, the mixing of the two fractions of the 2-component system may also be accomplished in a mixing chamber of an application nozzle directly prior to the pressure-induced spraying. The pot lives are a product of a combination of type and concentration of initiator and accelerator, the monomer composition, and external influencing factors, such as the ambient temperature, for example. These factors are easy to estimate and to adjust for the skilled person. Generally speaking, working pot lives amount to a number of minutes to a number of hours, and may exceed the 20-hour mark.

A further subject of the present invention is a method for the intumescent coating of a metal surface. In this method, the above-described formulation for 2-component intumescent coating is prepared, is applied within 1 to 20 minutes to the metal surface, and cures there within 60 minutes at a temperature of between 0 and 30° C. The preferred coat thickness of the unfoamed coating is 1 to 20 mm, preferably 2.5 to 7.5 mm. The formulation here will be such that the coating in a fire scenario would result preferably in a foam layer thickness of 20 to 100 mm, preferably 30 to 50 mm.

### EXAMPLES

The glass transition temperatures reproduced in the claims were calculated using the Fox equation and are authoritative. As a check the glass transition temperature was determined via DSC. Deviations from the values determined using the Fox equation were found to be less than 2° C.

The measurement of the glass transition temperatures using DSC is made according to DIN EN ISO 11357-4 with the following measurement programme:

1.) Cooling to −30° C. and temperature hold for 10 min

2.) Heating from −30° C. to 60° C. at 10 K/min

3.) Temperature hold at 60° C. for 5 min

4.) Cooling to 0° C. and temperature hold for 5min

5.) Heating of sample from 0° C. to 120° C. at 10 K/min

6.) Temperature hold at 120° C. for 5 min.

The determination of the glass transition temperature is made in step 5.). Apparatus used was as follows:

DSC 1, dynamic heat-flow scanning calorimetry from Mettler Toledo Analytical balance accurate to 0.001 mg Crucible and universal crucible press from Mettler Toledo

The molar weight was determined using gel permeation chromatography (GPC) in line with DIN 55672-1: SDV columns Eluent: THF with 0.1 weight % addition of trifluoroacetic acid Measuring temperature 35° C. Universal calibration against polystyrene standards and conversion to PMMA equivalents via Mark-Houwink relationship.

### Example 1:

The monomer mixture, consisting of 44.64 wt % of MMA, 46.24 wt % of ethylhexyl methacrylate, 8.81 wt % of n-butyl methacrylate and 0.31 wt % of beta-CEA, is mixed at room temperature with di(4-tert-butylcyclohexyl) peroxydicarbonate or 2,2′-azobis(isobutyronitrile) for the target molecular weight of 60 000 g/mol. A 50% fraction of the monomer mixture as a preliminary batch is heated with stirring to 74° C.: the heating is shut off and at 86° C., by continuous addition of the fraction of the monomer mixture accounting for the second 50%, polymerization takes place autothermally at 93° C. After a metering time of around 30 minutes, the procedure is at an end. Following the after-reaction time, the batch is slowly cooled to 30° C. and is stabilized with 15 ppm (15 mg/kg) of 2,6-di-tert-butyl -4-methylphenol (Topanol O).

The viscosity is determined via the 55 s flow time from cup 4, corresponding to 30-150 mP*s at 20° C. The target polymer content is around 25%. According to the Fox equation, the polymer formed has a glass transition temperature of −7.71° C. and is not crosslinked.

### Example 2:

The monomer mixture, consisting of—based on the total amount of the monomers employed—15.09 wt % of ethylhexyl methacrylate, 8.81 wt % of n-butyl methacrylate and 0.31 wt % of beta-CEA, is introduced at room temperature into a 1L jacketed reactor and then mixed with the initiator, tert-butyl 2-ethylperoxyhexanoate (TBPEH), and the chain transfer agent, 2-ethylhexyl thioglycolate (TGEH). The amounts are adjusted for the target polymer weight of around 60 000 g/mol. This reaction mixture is heated with stirring at 75° C. (water bath).

The reaction commences after around 15 minutes, and a steady rise in temperature by around 15 to 20° C. is observed. After around 2.5 hours, the maximum temperature is reached and the procedure is at an end.

The internal temperature falls. At around 80° C., the thermostat is set to 80° C. and the batch is after-reacted for around an hour. During this time a rise in the viscosity is observed.

Before being cooled, the polymer is diluted with a second monomer mixture, consisting of 44.64 wt % of MMA and 31.15 wt % of ethylhexyl methacrylate, and is stabilized with 15 ppm (15 mg/kg) of 2,6-di-tert-butyl-4-methylphenol (Topanol O).

The viscosity is determined via the 30 to 80 s flow time (cup 4) at 20° C. This corresponds to a viscosity of 30 to 150 mPa*s. According to the Fox equation, the polymer formed has a glass transition temperature of 5.4° C. and is not crosslinked.

The target polymer content is around 25%.

Use example:

42 wt % of the reactive resin from Example 1 are preformulated in each case with 29 wt % of ammonium phosphate, 8 wt % of pentaerythritol, 10 wt % of melamine and 10 wt % of titanium dioxide. These formulations are then divided into two fractions of equal size, with one fraction being admixed—based on the overall formulation—with 0.5 wt % of N,N-dimethyl-para-toluidine, and the other fraction being admixed with 0.5 wt % of benzoyl peroxide. These two fractions are subsequently mixed with one another and a small portion is removed. With the larger portion, a steel plate is coated in a coat thickness of 7 mm, while the smaller sample is used for measurement of the pot life and of the maximum temperature after mixing. The pot life, being the time within which the viscosity is ideal for application of the coating, was 13 min. The maximum temperature of 59.8° C. was attained after 40 min.

1. A process for preparing a reactive resin for intumescent coatings, the process comprising:
polymerizing a monomer mixture comprising at least one acid-functional monomer to a degree of polymerization of not more than 70%, and
discontinuing polymerization, to obtain a resultant polymer, wherein the resultant polymer has a glass transition temperature of less than 23° C.

2. The process according to claim 1, wherein the monomer mixture comprises at least 90 wt % of acrylates and/or methacrylates.

3. The process according to claim 1, wherein the at least one acid-functional monomer comprises acrylic acid, methacrylic acid, itaconic acid, and/or 2-carboxyethyl acrylate.

4. The process according to claim 1, wherein the monomer mixture comprises 20 to 60 wt % of MMA.

5. The process according to claim 1, wherein the monomer mixture consists of the at least one acid-functional monomer and at least one further monomer selected from the group consisting of MMA, n-butyl (meth)acrylate, isobutyl (meth)acrylate, ethyl (meth)acrylate, propyl (meth)acrylate, ethylhexyl (meth)acrylate, and styrene.

6. The process according to claim 1, wherein the monomer mixture contains up to 3 wt % of di- or trifunctional (meth)acrylates.

7. The process according to claim 1, wherein after discontinuing the polymerization, the polymeric constituent has a weight-average molecular weight Mw of between 10,000 and 200,000 g/mol.

8. The process according to claim 1, wherein the resultant polymer has a glass transition temperature of between −20° C. and 20° C.

9. The process according to claim 1, wherein the degree of polymerization on discontinuation of the polymerization is between 10 and 50 wt %.

10. A formulation for a 2-component intumescent coating, wherein the formulation after mixing of the 2-component system contains:
30 to 50 wt % of the reactive resin preparable according to claim 1,
35 to 60 wt % of a blowing agent,
0.1 to 2.5 wt % of a peroxide and/or azo initiator,
optionally up to 2 wt % of an accelerator,
optionally 4.9 to 15 wt % of at least one additive, and
5 to 30 wt % of at least one filler.

11. The formulation according to claim 10, wherein the formulation additionally contains pigments.

12. A method for intumescent coating of a metal surface, the method comprising:
preparing the formulation according to claim 10,
applying the formulation within 1 to 20 minutes to the metal surface, and
curing the formulation within 60 minutes at a temperature of between 0 and 30° C.

13. The process according to claim 3, wherein the at least one acid-functional monomer comprises 2-carboxyethyl acrylate.
